(19) United States
(12) Patent Application Publication
(10) Pub. No.: US 2013/0018586 A1
(43) Pub. Date: Jan. 17, 2013

(54) Field and Crop Information Gathering System

(71) Applicants: Todd A. Peterson, Johnston, IA (US); Douglas L. Gardner, Johnston, IA (US); Troy Wm. Hobbs, O'Fallon, MO (US)

(72) Inventors: Todd A. Peterson, Johnston, IA (US); Douglas L. Gardner, Johnston, IA (US); Troy Wm. Hobbs, O'Fallon, MO (US)

(73) Assignee: PIONEER HI-BRED INTERNATIONAL, INC., Johnston, IA (US)

(21) Appl. No.: 13/618,692

(22) Filed: Sep. 14, 2012

Related U.S. Application Data
(63) Continuation of application No. 11/451,054, filed on Jun. 12, 2006.

(51) Int. Cl. G06F 19/00; G01W 1/00; G01W 1/14

(52) U.S. Cl. 702/3; 702/19

(57) ABSTRACT

A method, apparatus, and system related to field and crop information gathering. In one aspect of the invention, data is obtained from a producer. One example would be yield map data from a yield monitor. Another is “as planted” data from precision farming planting equipment. The data includes information about seed or crop in a producer's field and an identification of the field. The data is combined with other information in a report. The information added could be, for example, soil type information overlaid on the field map. Another example is environmental classification information overlaid on the field map. The report is returned to the producer and used to discuss planning related to the field and the seed or crop.

### CROSS REFERENCE TO RELATED APPLICATIONS

This application claims priority under 35 U.S.C. §119 of provisional applications U.S. Ser. No. 60/722,365, filed Sep. 30, 2005, herein incorporated by reference in its entirety, and U.S. Ser. No. 60/689,716, filed Jun. 10, 2005, herein incorporated by reference in its entirety. This application claims priority from U.S. patent application Ser. No. 11/451,054 filed Jun. 12, 2006, which is hereby incorporated herein by reference in its entirety.

### I. BACKGROUND OF THE INVENTION

A. Field of the Invention

The present invention relates to methods, apparatus, and systems to obtain information related to agricultural fields, and the crops in those fields, and processing of the information into a useful form. In one aspect, the invention relates to using the processed information to recommend to the crop producer varietal or hybrid type or types for future growing seasons, and provide other direct services to the crop producer. In another aspect, the invention relates to using the processed information from the crop producers to improve performance of the crops through seed advancement experiments. Another aspect involves using the processed information in conjunction with other value-added goods and services, with the goal of increased information exchange with crop producers and increased assistance to and services made available for the crop producer.

B. Problems in the Art

Traditionally, crop producers relied on their own experience and analytical skills to manage their farming. For example, experience and empirical knowledge would tend to drive their selection of a seed supplier and the variety of seed for a given crop and a given field. Advice might be taken from other farmers or seed company representatives, but the farmer ultimately used his/her intuition to make farming decisions. This would include selecting specific hybrids or varieties of seed.

The present complexity and economics of farming has put tremendous pressure on crop producers. The substantial and continuing explosion in genetic engineering of seed has also made it difficult for crop producers to have confidence in relying on intuition and hearsay.

Some farmers have hired farm management companies to assist in some planning and decisions. However, the farmer must rely more heavily on the hired consultant. This is sometimes difficult to do because it removes a level of direct involvement of the farmer from decisions that affect his/her land and livelihood.

There are many variables involved in the optimization of output or productivity of a farmer. Some apply to most farmers, but not all always apply to all farmers. Therefore, individual attention to individual farmers and there particular needs or desires is important.

A need has been identified for a way to allow the crop producer to be actively and directly involved with crop selection and field management decisions, but with better information and increased confidence the information is helpful in making decisions that will improve results.

### II. SUMMARY OF THE INVENTION

A. OBJECTS, FEATURES, ADVANTAGES, ASPECTS

Therefore it is a primary object, feature, aspect, or advantage of the present invention to assist a company in knowing and understanding their customers better, with one purpose to provide the customer with products and services that will likely benefit the customer.

It is a further object, feature, aspect, or advantage of the present invention to assist in increasing contacts with a customer.

Yet another object, feature, aspect, or advantage of the present invention is to determine what particular fields a customer is farming to assist in making product recommendations or otherwise relate field locations back to operators and decision makers.

A still further object, feature, aspect, or advantage of the present invention is to combine an understanding of genetics-by-environment interaction with customer data to assist in making product recommendations or selections.

Another object, feature, aspect, or advantage of the present invention is to help growers to get more value from their precision farming investments.

Yet another object, feature, aspect, or advantage of the present invention is provide for a sales professional to work with a customer to collect and archive yield map data, provide a backup archive of the data, and deliver high quality yield maps and harvest summary information back to the grower in a timely fashion.

Other objects, features, aspects, or advantages of the present invention relate to an apparatus, system, or method which:
a. provide immediacy and fast turnaround of data about a field and the crop in the field relative to recommending and obtaining orders for seed for the next growing season.
b. reduce overhead and burden of labor and time to accurately and efficiently gather data from a crop producer and process it.
c. increase “face-to-face” or direct time with crop producer to promote better communication and exchange of information.
d. provide an efficient mechanism to gather data about fields and crops in fields from many, widely distributed crop producers.
e. allow storage of data about fields and crops in fields, as well as correlated information about the same, in a centralized form, and allow it to be mined and processed for use by an entity such as a seed company, or its sales force, or by crop producers, including use of information about individual crop producers or his/her fields or crops, or use of information about a plurality of fields.
f. provide a mechanism to not only gather data about fields and crops, but tie it back to the crop producer, and/or add feedback about the field, crops, or producer regarding performance of crops, or use the data for research and development of seed offerings.
g. provide a centralized archive of such data.
h. allow storing and archiving of the data off-site of the crop producer's land, but with access by permission.
i. allow integration with other systems or methods for improved products, services, and recommendations to crop producers, for example, use to help define environmental classifications.
j. allow integration with other systems or methods for improved products, services, and recommendations to crop producers, for example, estate planning, grain marketing, and financial planning related to the crop producer or the fields or crops in the fields.
k. allow integration with other systems or methods for improved products, services, and recommendations to crop producers, for example, use in product ordering and supply systems for a seed company.

A still further object, feature, aspect, or advantage of the present invention is to help producers choose the right hybrids and varieties for at least each field in each producer's operation.

One or more of these and/or other objects, features, aspects, or advantages of the present invention will become apparent from the specification and claims herein.

### III. BRIEF DESCRIPTION OF THE DRAWINGS

FIG. 1 is a diagrammatic view of an apparatus and system according to one aspect and exemplary embodiment of the present invention.

FIGS. 2 is a high level description of a methodology according to one exemplary embodiment of the present invention.

FIG. 3 is a diagrammatic view of a screen display for the portable computer of FIG. 1 according to one aspect of the invention.

FIGS. 4A-K is an example of a report generated by the system of FIG. 1.

FIG. 5 is a high level description of methodology according to an alternative embodiment of the present invention.

### IV. DETAILED DESCRIPTION OF EXEMPLARY EMBODIMENT

A. Overview

For a better understanding of invention, a description of one form or embodiment it can take will now be set forth in detail. It is emphasized that this is but one form or embodiment for exemplary purposes only, and is not to limit the invention, which can take many forms and embodiments and have variations such as are within the skill of those skilled in the art.

The exemplary embodiment described below is in the following context:
Crop producer—a farmer or other entity that grows corn.
Seed company—an entity that produces seed corn hybrids and varieties for purchase by crop producers, and engages in research and development to produce new hybrids and varieties.
Seed company representatives—persons, either employees or not, that represent a seed company or its products or service. Examples are employee sales representatives, field service agronomists (FSAs), or non-employee sales representations.

It is to be understood, however, that the invention has application to other crops, businesses, or subject matter. This detailed description is intended to give one example for illustration of the basic principles and aspects of the invention.

B. Apparatus/Kit

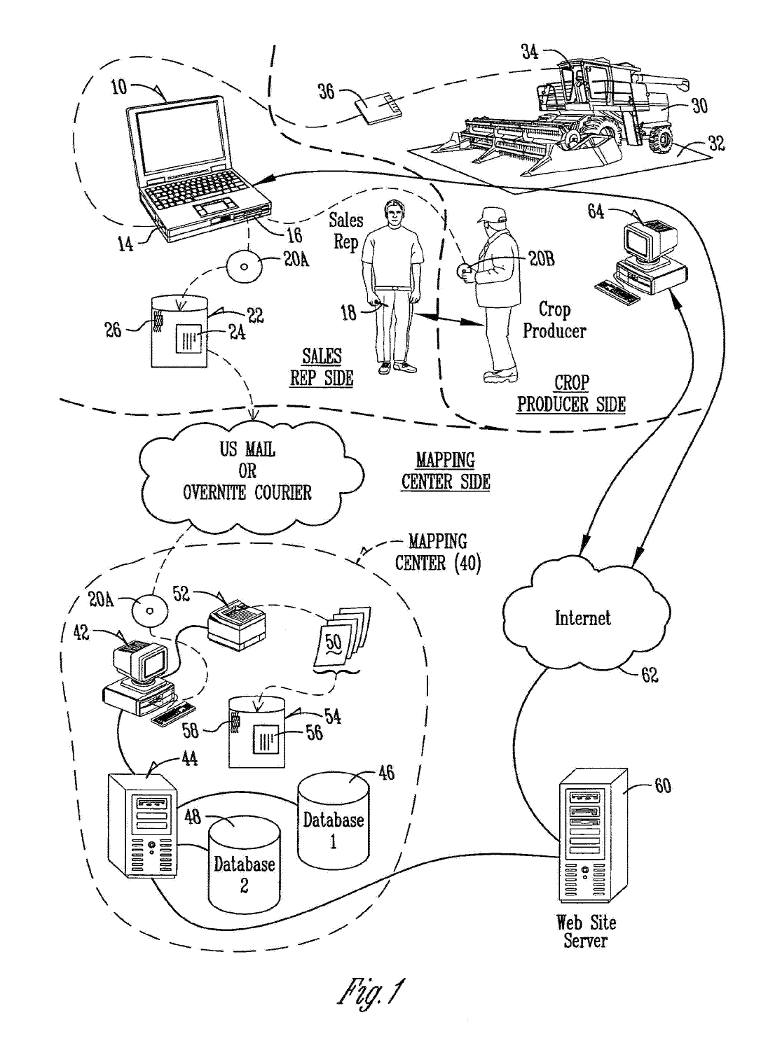

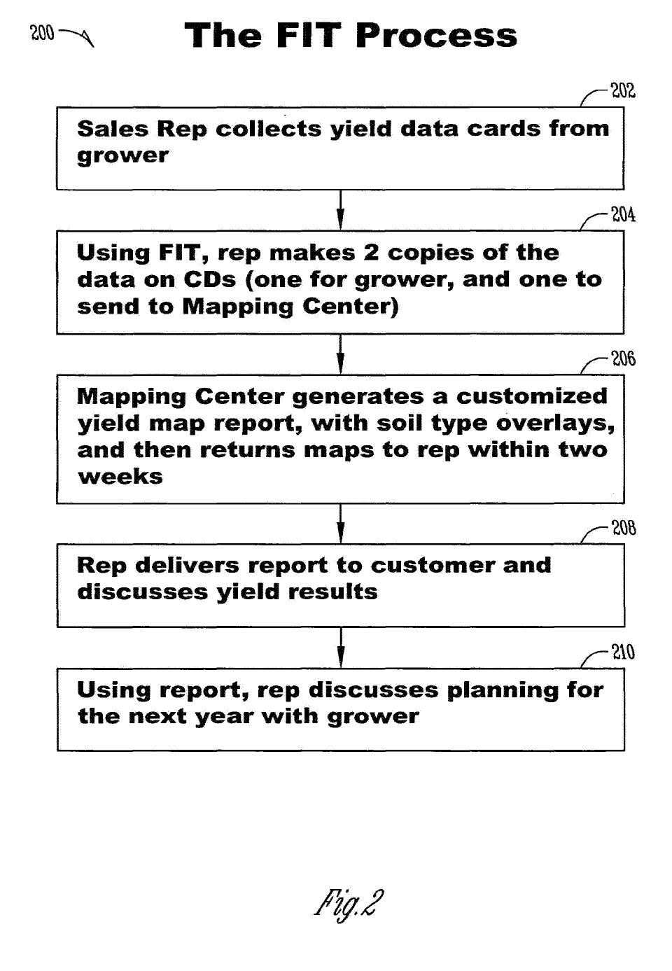

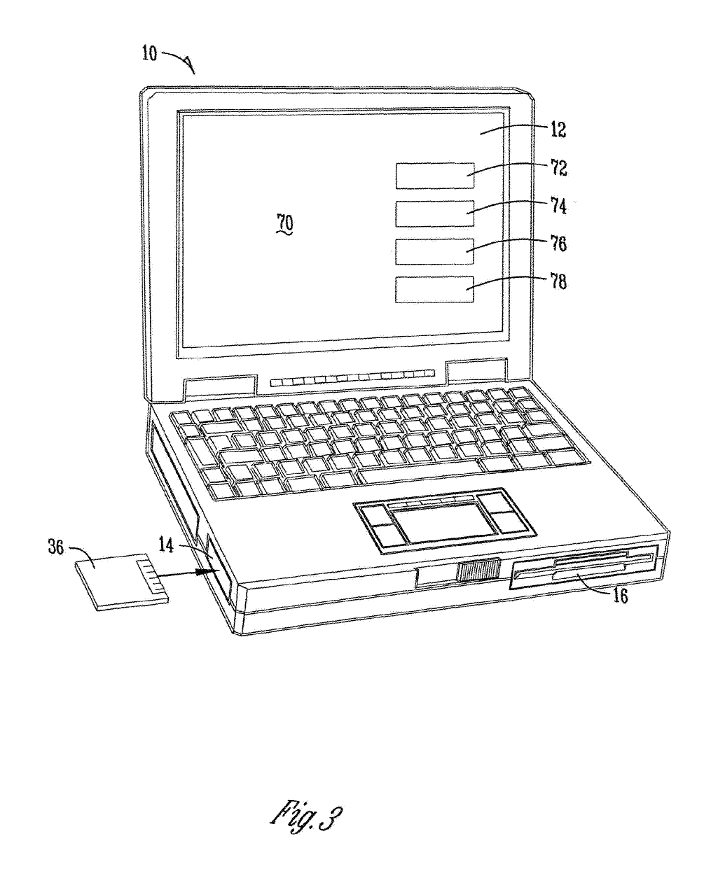

Apparatus used in a system of gathering information about corn fields and corn crops in those fields is diagrammatically illustrated at FIG. 1.

A sales representative of the seed company would be provided with the following kit of apparatus:
1. A conventional lap top computer 10 that can be operated on battery power out in a crop producer's field; lap top 10 including a display or screen 12 that can used by the sales rep and/or with the crop producer.
2. A data card reader 14 installed within, integrated with or connected to laptop 10 and adapted to receive and read conventional data cards 36 from most commercially available precision farming equipment 34 (e.g. such as those commonly in use on combine 30, particularly those that store yield information during harvesting and correlate it to geographic position in field 32), Equipment 32 and data cards 36 are available from a number of commercial vendors. Examples include various systems available from John Deere's (Greenstar®), AgLeader, and Case New Holland.
3. A CD-ROM reader/writer 16 adapted to transfer data from laptop 10 to a conventional CD-ROM in a format commonly readable by most personal computers or work stations.
4. A marker (e.g. Sharpie™ brand marker) to label a CD-ROM.
5. An envelope or container 22 with a pre-printed address label 24 ready to mail or send by overnight courier 28 a CD-ROM.
6. Software operatively loaded on lap top 10.

As illustrated in FIG. 1, in practice, the kit of materials interacts with both the crop producer and a central office, what will be called the mapping center in this embodiment. And, existing communications infrastructures can be used to communicate between the sales representative, the crop producer, and/or the mapping center.

C. Method

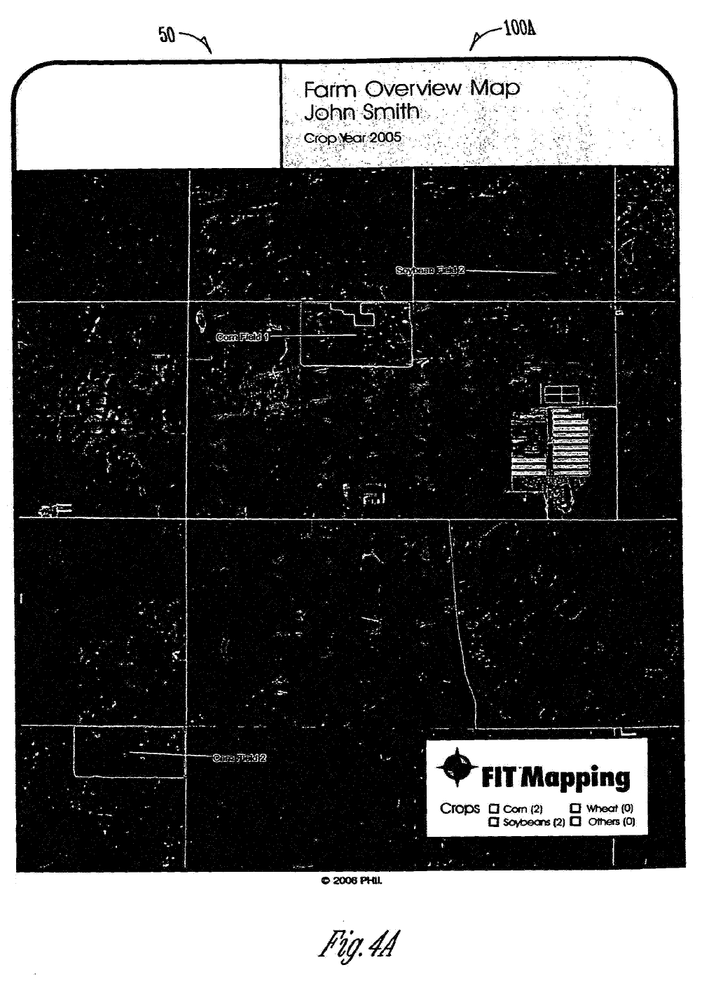

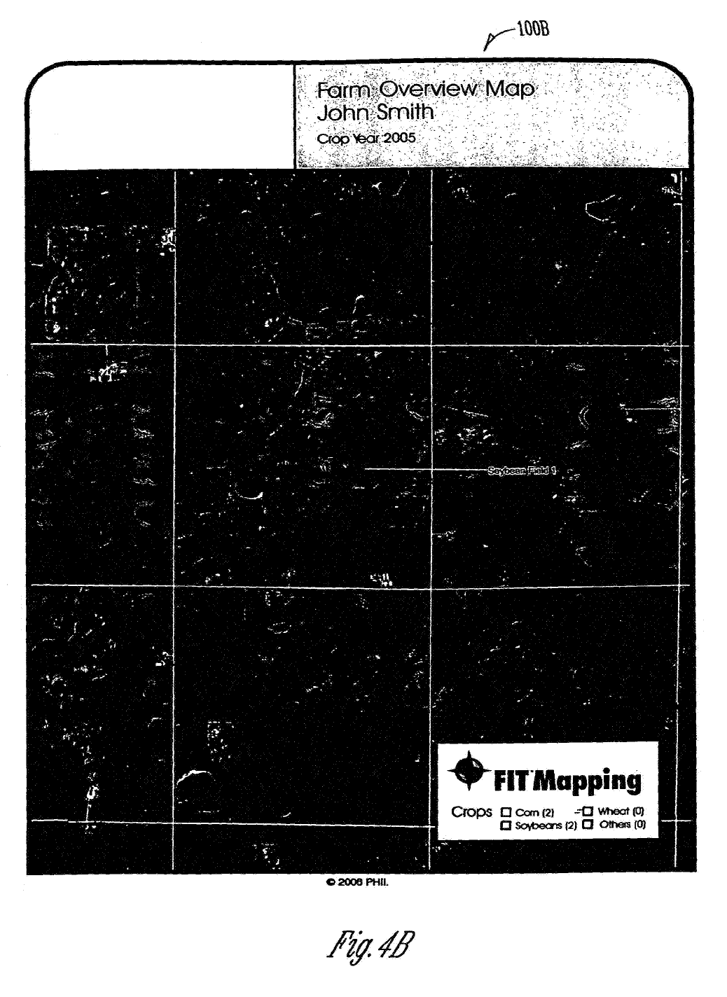

FIG. 2 gives a high level description of the methodology of the exemplary embodiment. The general steps of this method 200 are shown in FIG. 2.

Method 200 allows a seed company sales rep to help the crop producer get more value from his/her investment in precision farming technology through a service that collects and archives harvest information based on the precision farming available data, provide a backup CD (or other digital medium) of the producer's yield map data to the producer to control and keep in a safe and secure place, and deliver high quality yield maps and harvest summary information shortly after (or during) harvest.

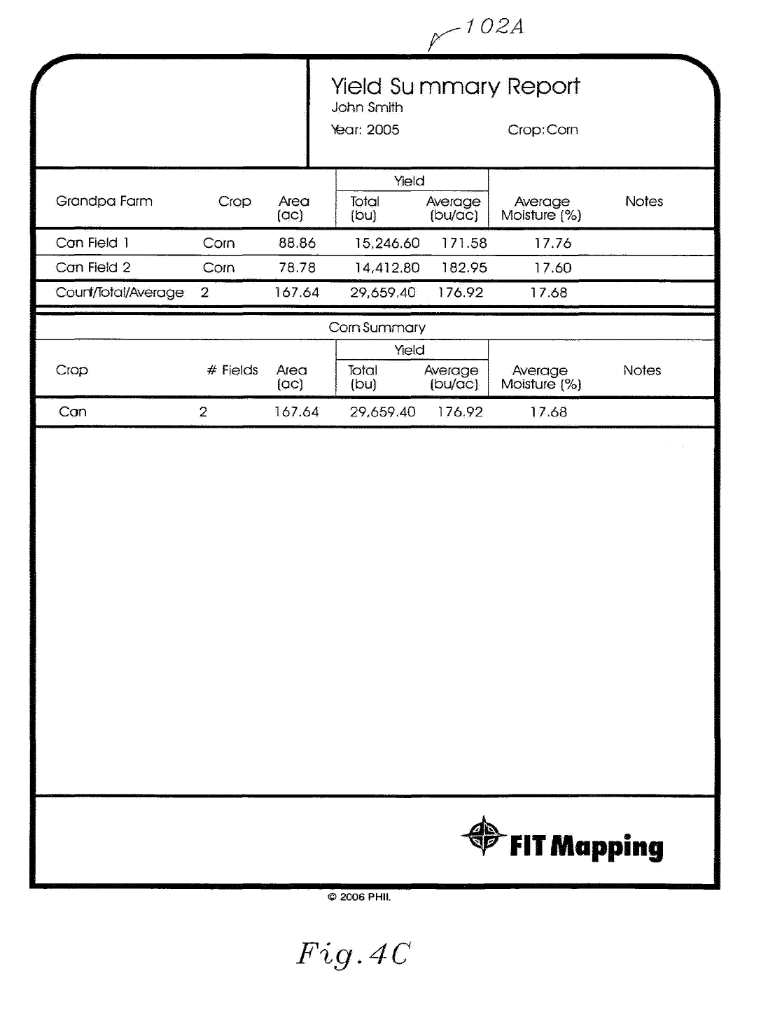

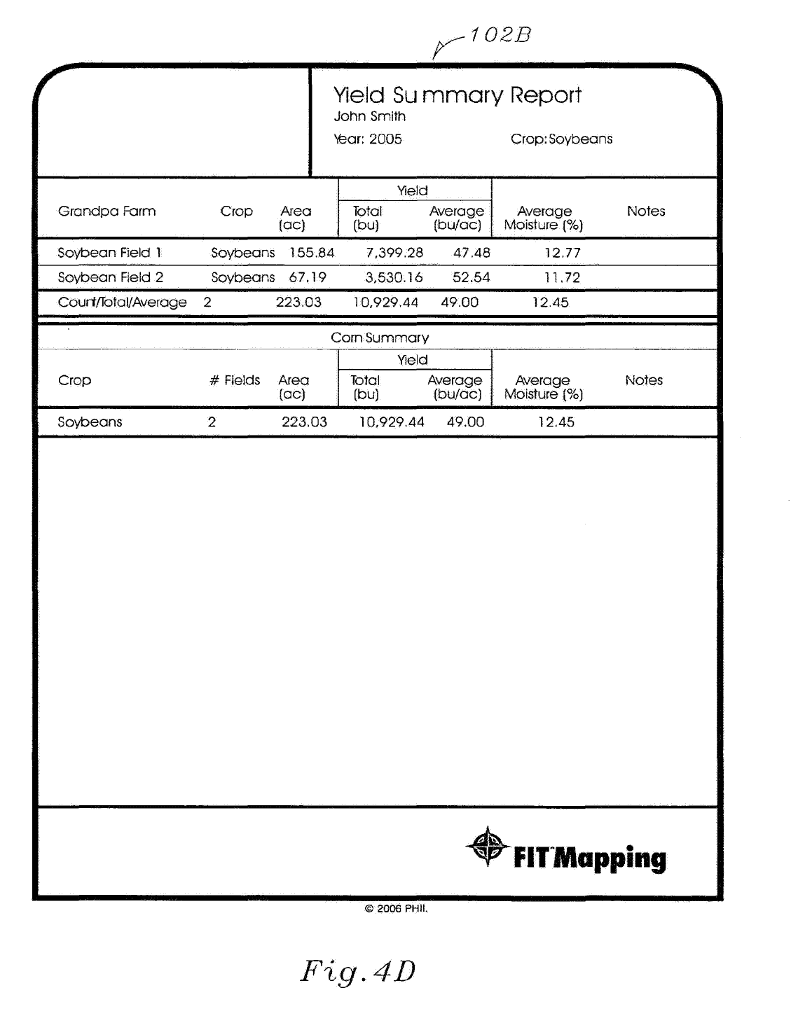

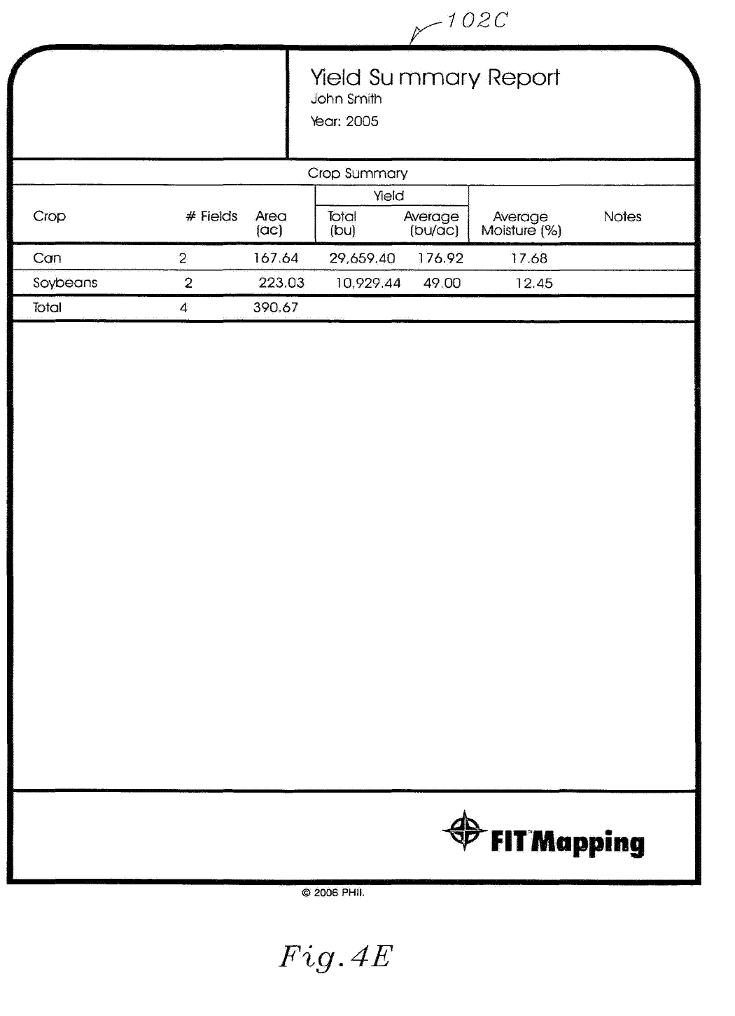

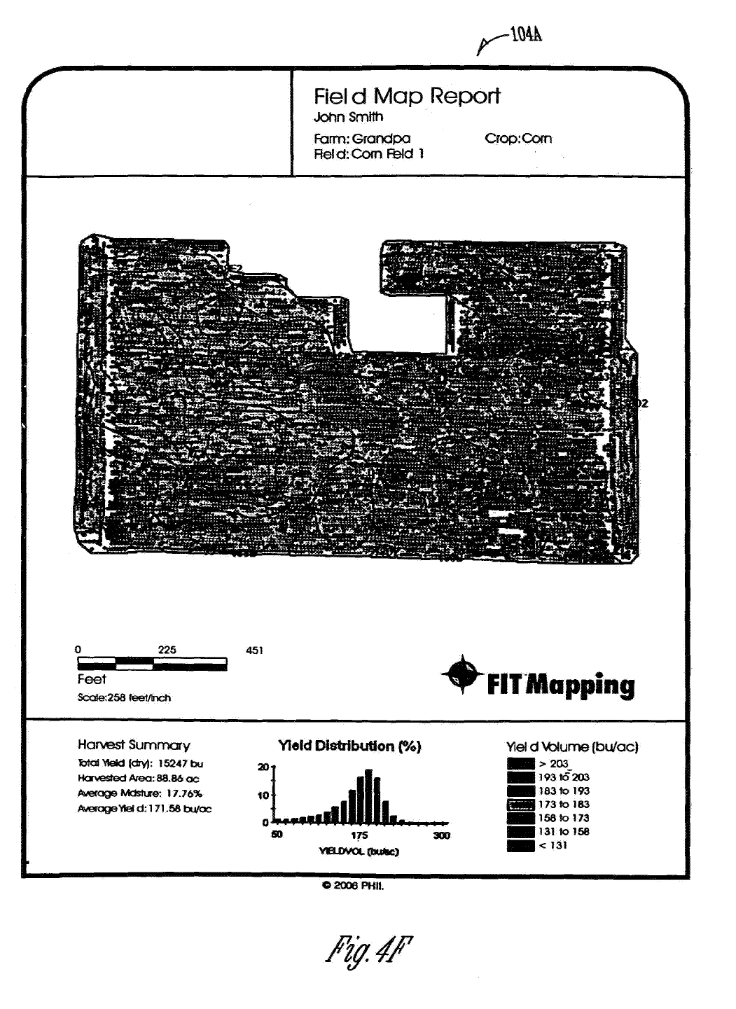

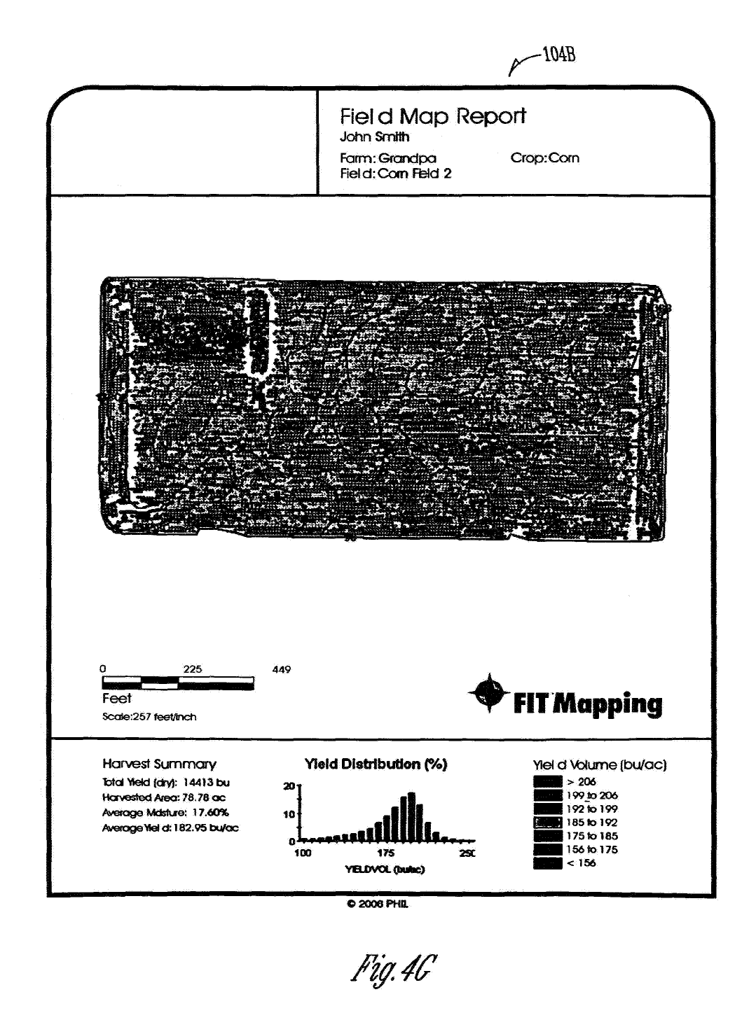

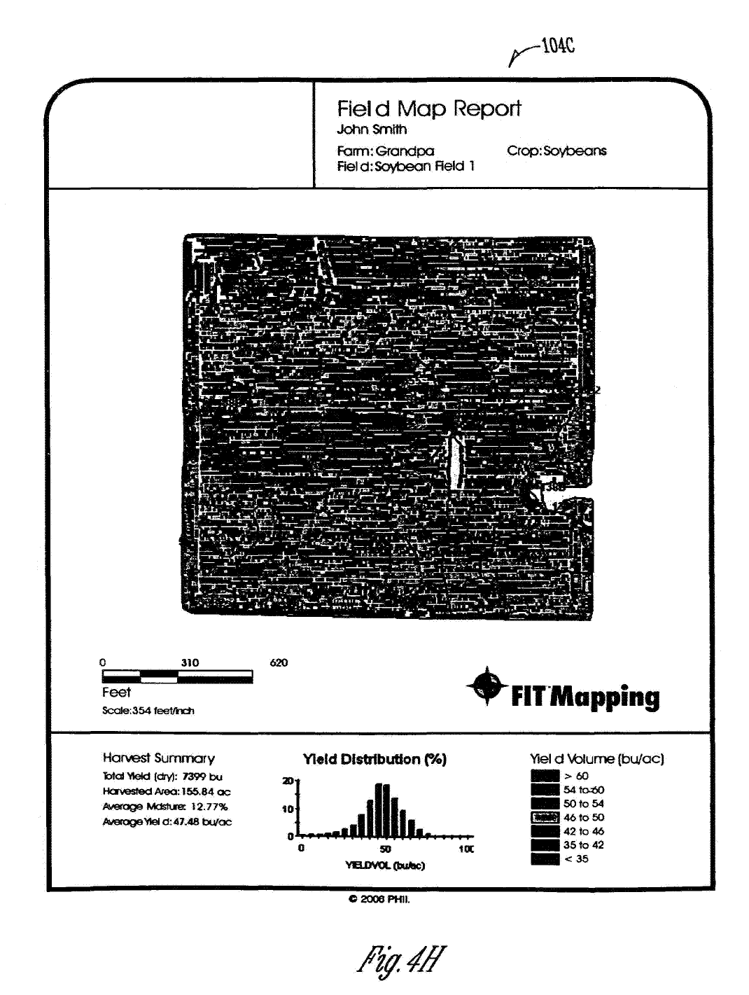

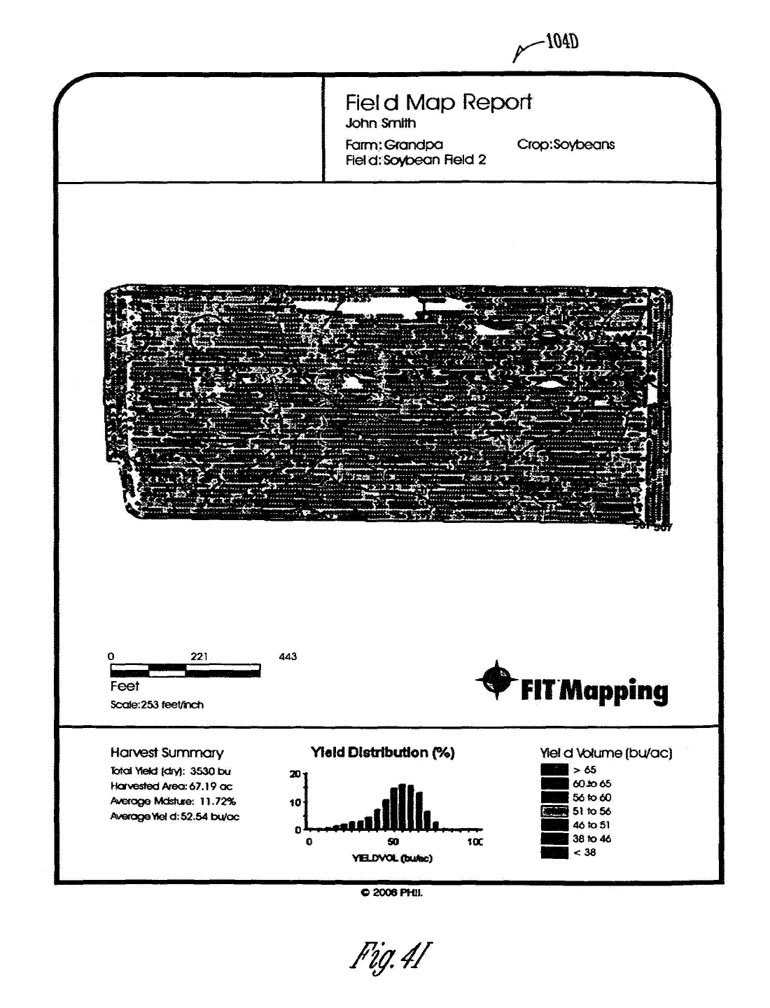

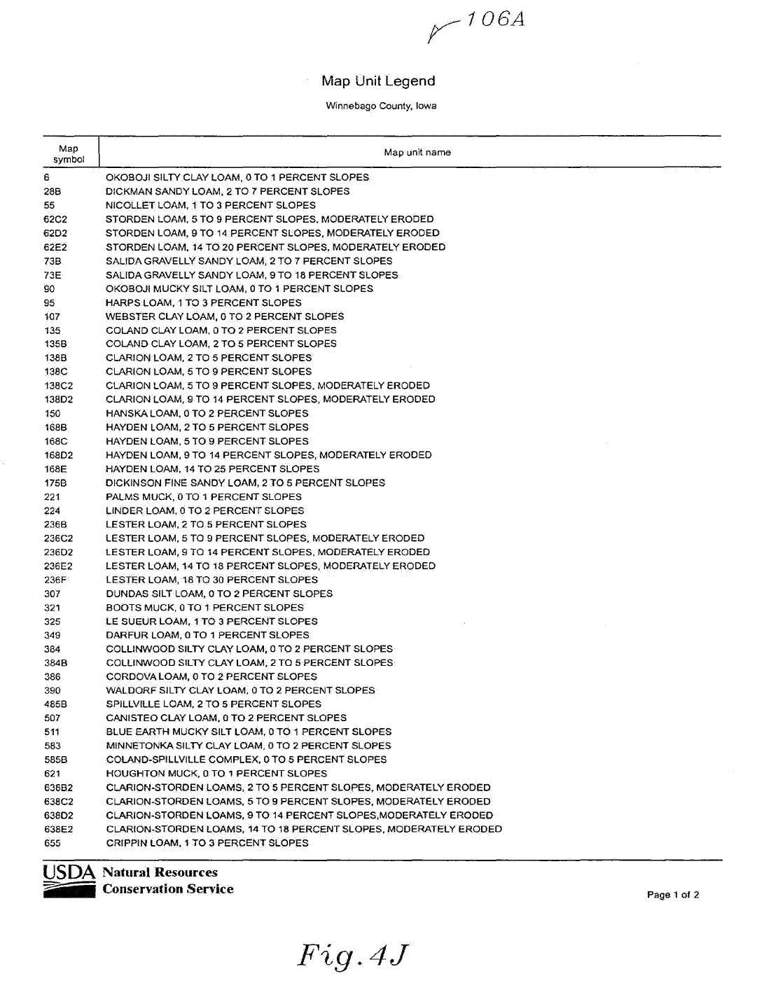

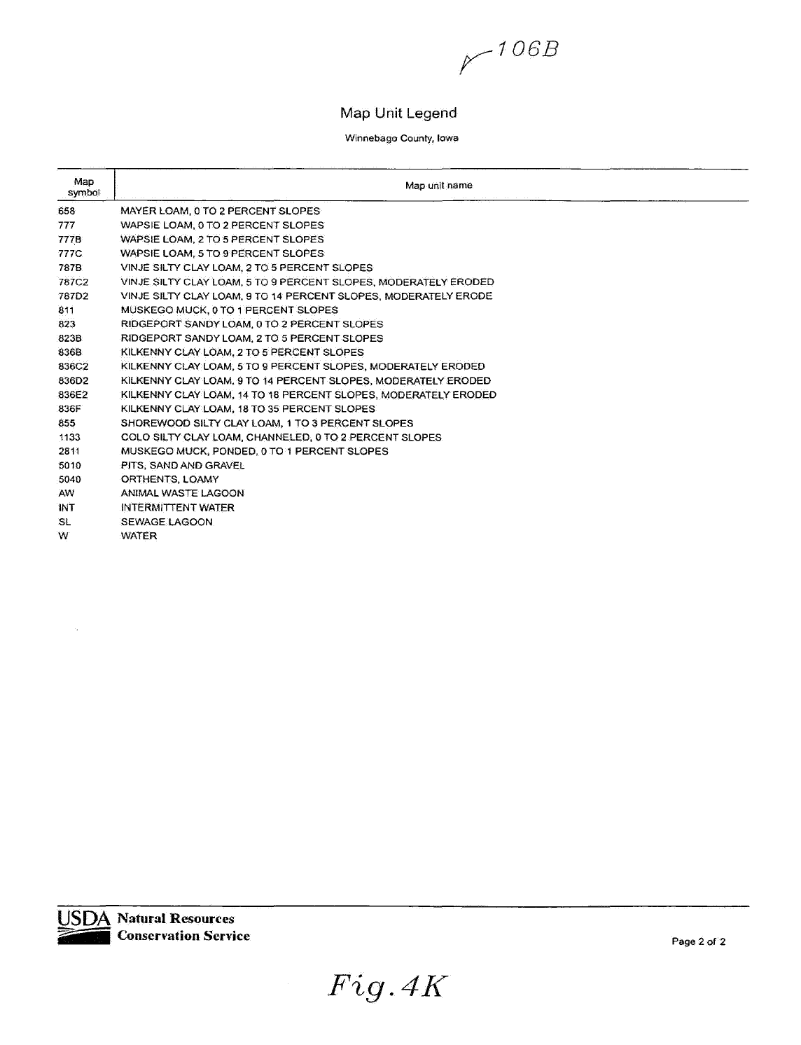

The kit described above can then be used by the sales rep as follows:
Step 202
   a. The sales rep travels to the location of a crop producer and, with permission, obtains data card 36 and reads the yield and geographic information for that field 32 with card reader 14 of his/her laptop 20.
Step 204
   b. The data read from card 36 is stored in resident memory of lap top 10, and is then used to burn two CD-ROMs with writer 16—a first CD-ROM 20A, which is placed into envelope 22 and sent to a mapping center 40; and a second CD-ROM 20B which is given to the crop producer to provide him/her with a personal archive copy of the data. Marker 18 can be used to label each CD 20A and B with identifying information. Software on laptop 10 provides an easy-to-use, quick, and almost fool-proof graphic user interface (GUI) to promote quick and accurate retrieval of the data. FIG. 3 diagrammatically illustrates one embodiment of the GUI, which will be discussed in more detail later. A sales rep can correlate identifying information related to CD-ROM 20A so that it is matched with supplemental information, e.g. the right crop producer, the name of the field used by the producer, etc.
Step 206
   c. Mapping center 22 is a centralized location that is configured to receive and process many CD-ROMs received from a number of sales reps distributed across a wide geographic area. A work station PC 42 is used to read and store the data from CD-ROM 20A.
   d. The data from CD-ROM 20A, and any identifying or supplemental information, is stored in database db 1 (reference number 46) in mini-computer 44. It is stored according to a protocol that allows it to be retrieved in whole or part, or integrated, or used to evaluate it, as well as similar data from a plurality of other fields and/or crop producers.
   e. Computer system 44 also has another database db 2 (reference number 48), which contains aerial photographs and soil type information matched to geographic location.
   f. Mapping center 40 has software that can be run which creates and prints on printer 52 a report 50 that is placed in mailer 54 (having address label 56 and postage 58), that is sent back to the sales rep. An example of a report 50 can be found at FIGS. 4A-K.
   g. Report 50 has the following components:
      (1) aerial photographs 100A and B from database 48, specifically showing one or more fields of the crop producer at issue and outlining his/her field(s), and overlaying the names or other identification of each field on the photos (see FIGS. 4A and B);
      (2) a harvest summary report 102A-C correlated by field name or identification for the outlined field(s) on photos 100A and B (see FIGS. 4A-B), as well as cumulative information about the harvest;
      (3) field maps 104A-D for each field in photos 100A-B and harvest summary report 102A-C, with graphic representation of yield across the field (see FIGS. 4F-I), and with a soil type overlay, using symbols to indicate different soil types across each field map 104 (and note that general direction of each pass of the combine is indicated by the distinguishable separate substantially linear graphic representations);
      (4) a key (106A and B) to the soil type symbols used on maps 104A-D (see FIGS. 4J-K).
Step 208
   h. Report 50 is taken for a face-to-face meeting with the crop producer, e.g. at the crop producer's location. It is used to show the crop producer the present performance of the seed used for the current crop. It is also used to provide the crop producer with information and intelligence about his/her fields and crops for future planning. The sales rep makes recommendations for purchase of variety or hybrid for next growing season.
Step 210
   i. The crop producer can make an order of seed, which can be communicated back to the seed company by the sales rep, via internet 62 and a seed company intranet.
   j. Additionally, the crop producer data and/or report 50 can be posted for access by the crop producer through his/her PC 64 via the internet (with appropriate passwords or other security to maintain privacy of such data).

The method provides a stream-lined, highly temporal, and valuable way to grab important data about the fields of crop producers, send them to a central processing center, and return an integrated report that is highly focused on imparting information useful to assist in face-to-face discussion of seed variety or hybrid performance relative to each piece of land of the producer. As can be seen by reviewing the exemplary report 50 of FIGS. 4A-K, the method provides the following types of advantages to the crop producer:
1. A systematic way to gather yield information that is married to geographic position directly from the crop producer.
2. A way to gather information at or close to the time of harvest, so that it can be used at the earliest possible time.
3. An opportunity to give back to the crop producer an archival or back up copy of his/her yield data.
4. A way to gain a better understanding of the crop producer and his/her crop practices to assist in better recommendations for next growing season. For example, the method provides better information to the sales rep about field-by-field practices. The sales rep can provide more focused consultation on seed varieties and hybrids on a field-by-field basis, rather than a generalized approach.
5. The crop producer is given a high quality, part visual, part textual report, not only summarizing yield information, but in the context of both field-by-field and total, with ancillary information like average moisture content, field size, soil type, and other statistical information (e.g. total bushels/acre, average bushels/acre, standard deviation—see FIGS. 4A-K). Thus, in one presentation, the sales rep and crop producer can view the numerical yield facts in the context of an actual aerial map showing the topography of each field outlined on that map, and in the context of field-by-field color-coded yield maps with soil type overlays.
6. Intelligence, in a condensed but informative package, from a representative of a seed producer, to assist the crop producer to make future seed purchasing decisions.
7. Information from the producer sufficient to determine which fields are being farmed by the producer.

Some examples of the advantages include the following. The method allows the farmer to outsource the overhead of collect and archiving data that is pertinent to making decisions about how the manage the land; including on a field-by-field basis. It allows the farmer to evaluate hybrids/varieties., observe crop variability within a field, determine effects of soil nutrients, prioritize irrigation/drainage/tiling investments, study management practices, compare weed control, and other factors to make decisions about crops, fields, and other management of the land. It allows a farmer to have or create a cogent and integrated report to communicate plans with business partners (e.g. lenders, land lords, farm management companies, etc.). It can provide an opportunity for the farmer to access the level of risk/reward he/she is willing to take or tolerate, and make calculated judgments about hybrids or varieties of the crop that will be planted next growing season that he/she believes will fit his/her elected risk level.

An example of this latter concept can be seen with the following illustration. If a producer wishes to try to increase profitability in the next growing season, he/she could select hybrids that have the potential of significantly higher yield in certain growing conditions for certain fields, but hedge or manage the risk by planting other fields with a hybrid that would perform well under different growing conditions. Like managing an investment portfolio, the farmer, in consultation with the sales rep and with the information of report 50, could decide on a hybrid mix (e.g. 70% of fields in hybrid X, and 30% in hybrid Y)

The method also involves a network of persons (the sales reps) that physically interface with the crop producers during the important time of harvest and give the sales rep the opportunity to understand the producer and his/her fields better, and be more educated and prepared to provide valuable advice and information to the producer. The method provides the following types of advantages for the sales rep:
1. A way to gain a deeper understanding of the crop producer, his/her land and crops on a field-by-field basis, and other information beyond just bare yield information, to allow better servicing of the customer, the crop producer. The sales rep, and the sales rep's company, can know each customer better and understand each customer's needs better, which is beneficial to both the customer/producer and the sales rep/company.
2. A way to use the data from the crop producer to give feedback, based on data relating to specific fields, and make better recommendations for the crop producer. It can provide tools to the sales rep that enhance the recommendations and customer interaction.
3. A way to have more face-to-face communication with the crop producer.

Stated differently, the method allows the sales rep to know the customer(s) (the crop producer(s)) better and understand his/her needs better, with the goal of using the method to maximize productivity and profitability for the customer. The ability to gather this type of data, process it has described, and then directly present it to the customer, can produce synergistic results. The sales rep can help the producer make the decisions described above, or consult and impart information about the different available hybrids that seem to best fit the producer's desired risk plan.

In a subtle, but important way, the method also provides an information gathering tool that benefits the seed company. The method allows the following types of advantages to the seed company:
1. A way to give better assistance to its end customers.
2. A way to gain a better understanding of hybrid or varietal performance over a geographically distributed area.
3. A way to obtain cumulative historical data on both field-by-field basis and wider basis for added-value back to individual customers as well as important data for use in seed advancement experiments, to develop hybrids and varieties that can ultimately benefit the crop producers. A knowledge base can be systematically built, based upon field-by-field data and field location. The knowledge can thus be tied to individual fields. This allows at least field-by-field resolution. It is not required to be tied to persons so that the knowledge base can be used, and updated, over the years even if the crop producer or owner of the field changes.
4. A way to gather, use, and return, in a relatively quick temporal sense, important information useful to crop producer, sales rep, and seed company.
5. A way to associate each producer with particular fields subject to their control. Alternatively, it allows the seed company (and sales rep) to know the history of discrete fields even if the land changes hands. By having the data in-house, it may be useful to provide good intelligence about a piece of land even though a prior land owner gave the yield data (i.e. such data may not be available but for having it gathered with permission from the prior land owner).
6. It can promote execution of employees of the company as a team. It can enhance the capabilities of the company's workforce.
7. It can help the company identify needs of its target customers, and thus forecast and plan for needs of the company.

As can be appreciated, the seed company can have the following benefits. It allows it to develop the best products and services for its customers. It also promotes a more integrated team of seed company, sales reps, and customers. Furthermore, it helps improve production efficiency for supply management. For example, by knowing quite soon in harvest season what the customers seem to be ordering for planting next growing season, the seed company can adjust production accordingly. As is well-known in the art, seed for planting can be grown in the opposite hemisphere during the winter in the crop producer's hemisphere, and then shipped to the crop producer's hemisphere in time for his/her planting season. Weeks, if not days, can be important in planning such production. The present method allows producer yield information to be taken during harvest, processed quickly at a central location (mapping center 40, e.g. at the seed company), and returned for face-to-face consultation with the producer—still during or closely after harvest. This accelerates recommendations and even orders for seed from the producer. Theoretically, orders can be taken during or immediately after harvest, communicated to the production locations in the opposite hemisphere, and production of indicated quantities of certain hybrids commenced.

Additionally, more face-to-face time and on-location data gathering can, in some cases, allow collect of other types of intelligence about the customer and the customer's operations. For example, the maps and yield information related to crops can provide intelligence on land use, all parties involved in the land (farmer, land owner, other related parties, third party service providers, suppliers, etc.), continuity of production, and the like. Intelligence about the producer's total operation can be possible through volunteered information from the producer or observations by the sales rep. This can even include gaining intelligence about what a producer is buying, not only seed, but other production resources (e.g. equipment, insecticides, herbicides, fertilizer, etc.).

As can be appreciated, such intelligence can be used by the sales rep and the company represented by the sales rep not only regarding individual producers/customers, but it can be aggregated and sorted or evaluated in ways that can assist in noticing collective trends or other details that can be advantageous. For example, it can provide information about what people are buying or land use trends. This can be useful not only in preparing for/predicting demand for seed varieties or hybrid types, but ancillary products like mentioned above (e.g. fertilizer, equipment, insecticides, pesticides, etc.).

Also, use of the producer's data from data cards 36 can be helpful to the seed company on a more macro scale. For example, data from a plurality of crop producers from a variety of locations can be integrated into a master database. This database would then contain valuable cumulative information. It could be used, for example, in developing and fine-tuning environmental classifications. These environmental classifications are further discussed below. Similarly it could be used to develop a long term historical database from which a variety of maps or predictions of performance of different hybrids could be based.

Such collections of data, built up over time, can produce a more valuable and accurate resource from which to predict performance, as it will give a better data set relative to the variables that can affect hybrid performance; e.g. weather, moisture, sun light, etc., as well as the conditions on almost a day-to-day basis. For example, if a growing season starts out abnormally cool and wet for a given location, but has a period of abnormally hot and dry weather, this can be valuable in understanding true performance of the hybrid.

From the foregoing, it can be seen that method 200 of FIG. 2 generally starts with data from the producer (e.g. yield per acre on a field-by-field basis). In turn, information is delivered back to the producer in a timely manner with added value (e.g. archival copy of customized yield map report, soil type overlays, and summary related to each producer field—see FIGS. 4A-K).Advantages can include improvement in agronomic practices of the producer. It can assist in selection of the best hybrid or variety for each field (they may differ from field to field). It can assist in evaluation of the producer's choices. It allows evaluation in conjunction with additional data (here soil types). It can also assist in ancillary practices (e.g. total farm operation practices, weed control options, equipment choices and options, chemical options and choices, irrigation/drainage/tiling investments).

Method 200 also allows assistance to the producer in management decisions and communications with business partners (e.g. financiers, chemical suppliers, etc.).

And, aggregation of data obtained from a plurality of producers can be useful to the company, as suggested above, but also to the producer. It allows the company to produce better products and services for producers, and give producers information of a wider scope than simply data about the producer's field(s).

D. Use With Environmental Classifications and Environmental Characterizations

One example of use of data from a plurality of producers, and their fields, is in generating what are called environmental classifications or characterizations. Details about environmental classifications and characterizations are set forth in U.S. Ser. No. 60/689,716, referenced earlier and incorporated by reference herein.

Generally, environmental classification or characterization relates to describing genotype by environment interaction and application of descriptions of the genotype by environment interaction to a broad range of specific applications. A “genotype” is generally defined as a cultivar, genetically homogenous (lines, clones), a hybrid of two or more parents, or heterogeneous (open-pollinated populations). An “environment” is generally defined as a set of conditions, such as climatic conditions, soil conditions, biotic factors (such as, without limitation, pests and diseases) and/or other conditions that impact genotype productivity.

With the advent of molecular biology, breeders became able to manipulate the genome of a plant through transgenics or the development of DNA based associations, for example, quantitative trait loci (QTL) mapping or marker-assisted selection, to obtain the desired phenotype. These molecular techniques are also advantageous in that the realization of a plant with the desired phenotype is achieved with efficiency, accuracy, and less expense than traditional breeding methods.

However, genetic manipulation alone does not ensure that a plant will perform well in a specific environment or for that matter a wide range of environments year after year. The performance or phenotype results from an interaction between the plant's genotype and the environment. An environment at a given location changes over the years making multi-environment trials (METs) performed in the same location limited as to inferences about future crop performance. Furthermore, inferences about a crop's future performance in different locations depend on whether the target population of environments (TPEs) is well sampled since the environment varies between different locations in one year. Therefore, the interaction of genotype with environment, referred to herein as G×E, is of primary importance in the research of major crops grown in a wide range of environments. G×E refers to a phenomenon where different environments may have different effects on different genotypes. Thus, analyzing G×E interactions provides information about the effect of different environments on genotype performance. The G×E information has application in planning and positioning, i.e. selecting products for land bases exhibiting a higher frequency of specific environmental classes, and crop modeling. The G×E knowledge and classified environments may be used in facilitating positioning and/or planning strategies, such as product lifecycle decisions, characterization of products, demand planning, inventory management, resource efficiency, risk management lexternal and internal), product positioning, and product selection. Subsequent to positioning and planning, the producer will grow the selected products and measure the performance results. The producer may also collect environmental and physiological landmark data and in conjunction with performance results use it in analysis. Analysis of environmental and physiological landmark data and performance results may undergo analysis using G×E analysis tools, including databases that store and/or integrate years of information related to geographic areas and/or products. The present system, called Environmental Classification, that takes genotype by environment (G×E) interactions into consideration when selecting the best hybrids for a particular land base.

The environmental and physiological landmark data may be historical using historical meteorological information along with soils and other agronomic information or collected using National Oceanic and Atmospheric Association and/or other public or private sources of weather and soil data. Potential environmental and physiological landmark data that may be collected includes but is not limited to wind, drought, temperature, solar radiation, precipitation, soil type, soil pH, planting and harvesting dates, irrigation, tiled area, previous crop, fertilizer including nitrogen, phosphorous, and potassium levels, insecticide, herbicide, and biotic data, for example, insects and disease. The environmental and physiological landmark data may then be analyzed in light of genotype performance data to determine G×E interactions.

Using the information collected for or from G×E analysis, the land bases may be categorized into environmental classifications. Categorizing land bases into environmental classifications has several advantages. First, environmental classifications can bring an understanding of the various environments under which crops are produced. Second, occurrence probabilities for each environmental category can be assigned to each geographic location and the frequency of the classifications determined using routine methods.

A correlation between a genotype's performance and a target environment or environmental classification will lead to more precise product placement since the genotype performance is characterized within an environmental class in which it is adapted and most likely to experience after commercialization, consequently resulting in improved and more predictable product performance. The analysis of G×E interactions facilitates the selection and adoption of genotypes that have positive interactions with its location and its prevailing environmental conditions (exploitation of areas of specific adaption). G×E analysis also aids in the identification of genotypes with low frequency of poor yield or other performance issues in certain environments. Therefore, G×E analysis will help in understanding the type and size of G×E interactions expected in a given region. Selection of hybrids using this method for a particular land base can improve agricultural potential of certain geographic areas by maximizing the occurrence of crop performance through the use of the environmental classification. In addition, this approach allows the use of statistical and probability based analysis to quantify the risk of product success/failure according to the frequency of environment classes and the relative performance of genotypes within each environment class. This early identification and selection of hybrids would enable seed producers to start seed production and accelerate the development of hybrids in winter nurseries in warmer southern climates.

Moreover, environmental classification allows for the creation of an environmental profile for all or any part of the land base classified. Environmental classifications can be determined for each producer's land base. Similarly, the environmental performance profile of cultivars/hybrids can be determined through field experimentation or predicted using G×E analysis. In combining environmental classification frequencies for a particular land base and product performance by environmental classification, performance measurements are given the appropriate amount of relevance or weight for the land base in question. For example, the data are weighted based on long-term frequencies to compute a prediction of hybrid performance.

Once genotypes have been identified and selected for performance for a particular land base or environmental classification using the present inventor's system, the genotypes will be developed for commercialization. As discussed previously, high performing inbreds may be produced from the appropriate parental germplasm for use in the development of superior performing inbreds. These inbreds may then be crossed and evaluated in various experimental hybrid combinations. Once a superior hybrid combination is identified, the hybrid may undergo further testing in various environmental classifications where G×E interactions can be evaluated. Once developed, the hybrid will undergo extensive seed production and marketing before being offered to producers.

Environmental classification can be used in the following ways: (a) to document the environmental profile over time of a crop producer's land base, (b) give the producer an environmental performance profile of crop cultivars, (c) assist the producer's objectives to select a portfolio of cultivars that maximizes and (d) quantify the probability associated with risk that the producer's objectives for productivity.

Environmental classification can be used to determine the primary environmental drivers of genotype by environment interaction in crops such as corn. That is, what are the primary environmental factors that cause change in the relative performance of hybrids. With this knowledge, crop production areas can be categorized into environmental frequency classes. Within these classes, hybrids tend to perform (as measured by yield) relatively similar to one another. Across these classes, the relative performance of hybrids tends to be significantly different. Using historical meteorological information along with soils, pests, and other agronomic information, the frequency of these environments can be determined. This allows the creation of an environmental profile for all or any part of the geography classified. That is, a frequency distribution of the occurrence of the key Environment Classes. This can be done for each crop producer's land base.

Thus, this information can be combined at the producer's level to optimize crop productivity in such a way that it maximizes the probability of the producer's business operation reaching its productivity goals. The present invention contemplates that information can be used from any number of classification schemes to the selection of cultivars with the objective of maximizing the probability of attainment of the productivity and business goals of a crop producer's operation.

One approach does so by using compiled long term geo-referenced weather, soils, and agronomic data including biotic factors for the producer's land base to categorize the land base in terms of how frequently annual environmental variation occurs to a degree that is likely to impact relative hybrid performance. In addition, it can incorporate the producer's business objectives including, but not limited to preparedness to take risk. Environmental variability can be combined with producer business information to create a producer profile. Product performance information stratified by the same criteria is used to define the producer's environmental profile (for example, environmental classes) which is then integrated with the producer's profile.

The relative hybrid performance information that is relevant to the producer's land base can be used regardless of when and where it was generated. It can be used to predict future performance of genotypes and quantify probability/risk associated with that performance using data from environments that are considered to be substantially equivalent in terms of relative hybrid response. The result is a more robust and predictive data set thus allowing more informed product selection decisions that, over time will result in a higher probability of a producer operation meeting business objectives for productivity.

Another aspect of the present invention relates to tools that can be used as sales and marketing tools to convey information about the environmental classification process to customers. The effectiveness of the environmental classification process is based in part on its ability to use historical data from many locations so that all available data is used. This aspect of environmental classification would seem counter-intuitive to a producer who primarily relies upon personal knowledge in the local area. The producer's confidence in firsthand production knowledge is used to assist in increasing confidence in environmental classification.

With particular reference to environmental classifications, method 200 of FIG. 2 can be used for research to better link relative yield to environmental classification. As discussed above, environmental classification can be used to determine the primary environmental drivers of genotype by environment interaction in crops such as corn. That is, what are the primary environmental factors that cause change in the relative performance of hybrids? With this knowledge, crop production areas can be categorized into environmental frequency classes. Within these classes, hybrids tend to perform (as measured by yield) relatively similar to one another. Across these classes, the relative performance of hybrids tends to be significantly different. Using historical meteorological information along with soils, pests, and other agronomic information, the frequency of these environments can be determined. This allows the creation of an environmental profile for all or any part of the geography classified. That is, a frequency distribution of the occurrence of the key Environment Classes. This can be done for each crop producer, including on a field-by-field level. A seed company can determine environmental classifications to be used in evaluating relative performance of different genotypes under different environmental conditions. Each land base, field, or region of field may have one or more environmental classifications that can be related to relative performance of different genotypes. The actual production history for a particular field, including the yield data received from a crop producer, or information elicited during discussion with the crop producer can assist in determining the proper environmental classification for each land base or portion thereof.

Therefore, not only can the seed company, or other entity, use the data from the producers to help create Environmental Classifications, once created, the Environmental Classifications could be used in consulting or selling to the producers. For example, in addition to the yield data combined with field maps with soil type overlays in the steps of method 200 of FIG. 2, the Mapping Center and/or sales rep could provide to the producer addition valuable information. One example is Environmental Classification information. This can tie in genetic characteristics of different seed with environment to assist in sales to or selection by the producer of seed varieties or hybrids. The advantages of Environmental Classification can help the sales rep make better recommendations to the producer.

Such information could be provided separately in Environmental Classifications illustrated on maps overlaid over the land base of the producer. They could also be included with or built into the maps of report 100.

As can be appreciated, the Environmental Classification information can be useful in advising about selection of seed for a field. This can be especially the case for new hybrids. A track record, so to speak, for new hybrids has not yet been established with farmers. However, the seed company knows the genetics of the hybrid, and is generally the only entity that does. In combination with Environmental Classification, the seed company can predict performance for different farmers.

Environmental Classification can also be used in more subtle ways. After harvest, it can be used to show a producer the validity or efficacy of selecting seed based on Environmental Classification. This can increase customer (producer) confidence in the recommendations, as well as customer (producer) loyalty.

Furthermore, as with method 200 of FIG. 2, adding the Environmental Classification component can likewise assist in advising, consulting, and cross-selling other goods or services. A few examples might be crop production equipment, crop production chemicals, business management services, etc. It can also supplement, facilitate and enhance communication and dealings with business partners.

E. Options and Alternatives

The foregoing exemplary embodiments are given by way of example, and not limitation. The invention can take many different forms and embodiments.

Variations obvious to those skilled in the art are included within the invention. Some examples of options and alternatives are given below.

1. General Examples

The invention can be applied, of course, to any of a variety of crops. Corn is mentioned above. Note also that reports 50 include some fields planted in corn, and some in soybeans. This illustrates another way how the data gathering system of the present invention allows the sales rep or seed company to learn about the crop producer. Still further crops include sorghum, canola, rice, and sunflower. Others are, of course, possible.

Data from the producer can be obtained in other ways. If the farmer has stored yield data, it could be downloaded or copied from whatever storage device the farmer has used. There are commercially available wireless communication devices that could be used to transfer data from the producer's precision farming system 34 directly to the sales rep laptop 10.

There alternatives to transfer the producer yield data to mapping center 40.

Again, highly accurate and secure wide area data communication methods are commercially available that could be used to transmit data from, for example, laptop 10 to mapping center 40. One example would be the internet. It could even be wireless, in whole or in part. The same is true for how reports 50 are communicated back.

Aerial photos 100 used in reports 50 can be obtained from a variety of sources. One example is satellite topography photographs from Microsoft's Terraserver. Other sources exist. They could be stored in databases or on-site memory storage at mapping center 44, or available by downloading from another computer via the internet.

Software to overlay the outline of a crop producer's field(s) on the aerial photo of report 50 would be well within the ordinarily skilled programmer. Alternatives to an outline could be used, e.g. solid color coding, the same or different colors for each field, or some other graphic way to distinguish the producer's field(s) from other land.

The information in harvest summary reports 102 can vary, as can the way it is formatted or presented.

The information and presentation of field map(s) 104 can also vary, as can how soil types are overlaid, or whether they are used at all. Soil types are available from public sources, e.g. the United States Department of Agriculture (USDA) Natural Resources Conservation Service. The software to overlay soil type symbols on the yield maps 104 is well within the skill of the ordinarily skilled programmer. One alternative or option would be to present maps 104 for multiple years for each field, or produce map 104 from multiple years of yield data. For example, instead of just looking at a field map like 104 for just the prior season's harvest, it could show yield across the field based on two, three, four, or even more prior harvests from that same field, if the data is available.

Multiple year data can be put into overlays for maps to assist the producer in making decisions. It can assist in “fine-tuning”, so to speak, the history and performance relative to individual fields over a plurality of years, and thus, a plurality of conditions. This can assist the producer. It can also assist the sales rep.

Moreover, multiple year data from producers can assist in “fine-tuning”, so to speak, Environmental Classifications. More data over more years can contribute to this.

Still further, more data can provide more and better “feedback”, so to speak, to producers, sales reps, and seed companies, including the research and development branch of seed companies. The following are a few examples.

For producers, the feedback of multiple years of information can provide validation of either actual performance and performance predictions in the past, or give more comfort that performance predictions in the future are likely to be met. If the producer has achieved success, for example, with Environmental Classification used in hybrid decision-making in the past, the feed back can validate this. It can also give a greater comfort level that similar success will be achieved in the future. It can show what went well, what changes might be needed, and what might be expected. As previously mentioned, each producer has his/her own problems, soil conditions, etc. This can allow the producer to feel more comfortable with decisions on not only the hybrids to plant in each field, but also decisions regarding ancillary things like financing, equipment, and labor. For example, it can help plan what type of contracts to form to sell the crop in the future. It can help make decisions on hiring labor or buying equipment. It can help in communications and negotiations with entities such as land lords, suppliers, or financiers, if applicable. As can be easily envisioned and understood, maps could be created for not only the producer, but for the sales rep, the seed company, and/or other entities.

This can also help the sales rep gain a better understanding of the producer and each of the fields of the producer. It allows the sales rep to get more trust and confidence from the producer. It helps the sales rep make recommendations to the producer. One prime example is it assists the sales rep in making recommendations of hybrids for each field of a producer based on Environmental Classification. A goal is to place the best hybrids in fields. This can include the best hybrids for the Environmental Classification for each field.

It can help a seed company in the research and development of hybrids, in the pricing of hybrids, in the prediction of performance of hybrids, in inventory management for a plurality of hybrids, etc. For example, multi-year yield data from producers can help fine-tune and validate performance of hybrids, it can be of assistance to research for better performing hybrids, and it can help in the pricing and sales of developed hybrids.

Additional information could be included in report 50. As mentioned above, Environmental Classification or related information could be included. Specific geo-referenced information could be included. Information about crop variety or hybrid could be included. Comparisons between information or fields could be made. For example, comparison of specific genetic information between two fields could be included. Specific temporal information could be included. For example, the time signal from a GPS signal could be used to record time of harvest and store that with the yield data of a field.

Another example is more information about the producer. It could include more detailed identifying information, historical information, or other information, even information not specifically about the seed or crop.

Another option, briefly discussed earlier, is the ability to provide the producer access to the data he/she provided to the sales rep. As illustrated in FIG. 1, one example could be through an internet website. The seed company could provide limited access (e.g. password protected access) to each producer for only that producer's data. Still further, the system could be expanded to allow the producer to submit orders, or transact other business with the seed company electronically, including through such a website. Another option would be for the seed company to provide applications via the internet that could be useful to producers. For example, estate planning software tools or programs could be made available. Other examples would be applications or links which allow the producer to market his/her grain (or future grain), or use yield data for financial planning or financing. Another possible application would be planning software that would allow the producer to enter different scenarios and see projected results. This could help the producer make decisions. The data could also be integrated with a management services application, where the seed company, or another entity, could use the information to provide farm management services to the producer.

Examples were given regarding how the invention can be advantageously used by the seed company for internal purposes. Additional examples include planning and design of seed conditioning processes, product movement, product inventory, and research.

2. Software Examples

One example of software that could be used to read data cards 36 is illustrated via the GUI 70 of FIG. 3. As shown, even a sales rep without high computer skills could follow the steps. Once data card 36 is plugged into reader 14 on laptop 10, GUI would tell the sales rep to push or click button 72, which would automatically start the read function. The software would be programmed to recognize many or most of the commercially available precision farming devices 34 (e.g. by recognizing distinct formats or type of data), and ask the sales rep, via a prompt on display 12, whether the data card is from a certain device 34 (e.g. John Deere Greenstar system). The sales rep just has to select from a “yes” or a “no” button 74 or 76, based on the personal knowledge the sales rep would have because he/she has obtained the data card 36 from the producer. The software would then prompt the sales rep to enter who gave him/her the data card 36 (e.g. at button or position 76 on laptop display 12). The sales rep enters the producer's identifying information, and the process is done.

Further, one option of the method would be to post the report 50 automatically to a producer-accessible web site shortly after the target two week turn-around time for the face-to-face meeting (e.g. on the 17^{th} day after reading the data card 36 for that producer). The computers at the mapping center 40 could be programmed to automatically do this to provide this information to producers after at least the chance for a quick turn-around face-to-face meeting, to allow the producer to have time alone to review it or use it for other purposes.

3. Communication Examples

The basic method principles discussed above could be used in conjunction with a variety of communications regimens and systems. For example, by commercially available technology, the sales rep can be put into communication with any of the crop producer, the mapping center, or other entities or terminals. Wireless communications, including over the internet, can facilitate this. The mapping center, or the seed company, could serve as a data hub for a plurality of sales reps and producers (and/or other parties). Other services could be provided. For example, as a data or communications hub, a variety of tools or information sources could be made available to any authorized user. Information of interest to crop producers could be posted. On-line or downloadable software tools could be made available that could help producers with decision-making. Individual secure databases could be made available for any producer to store information. A collective database could be created, allowing any number of producers to add information. Links could be posted to electronically link producers to the marketplace for their crops. There could be a link to the designated sales rep for a producer, to give direct, convenient communication access. There could also be links to inventory control, work order agents, or other branches of the seed company that could be automatically notified and databases updated. These are but a few examples.

Note, too, a variety of communications alternatives exist. One example would be to electronically transfer the yield map data from the producers to Mapping Center 40, and then the information that is otherwise on CD-ROM 20B and Report 100 back to the producer, instead of using the mail or overnight courier. There could be a website that allows authorized access to such information.

Furthermore, as can be easily appreciated, there could be communications links to other parties or entities. For example, there could be a direct and automatic or semi-automatic link to the seed company sales department when a producer makes a seed selection with a sales rep. This could also be a link to inventory control, work order department, research and development, and/or other aspects of the sales system. Reports could be generated. For example, a report could be generated indicating what amount of certain hybrids should be produced for inventory based on Environmental Classifications and knowledge of genetics of the hybrids, as well as indications of possible purchases or actual purchases or both.

4. Ancillary Services Examples

Previously, there have been some examples of how the basic methodology could be used in conjunction to what might be called ancillary services. An example discussed above was the ability to use report 100 to not only discuss seed options with a producer, but also discuss overall business management or operations of the producer. The possible services are not restricted to seed decisions. For further example, business recommendations can be made to improve productivity related to production factors like labor, equipment, financing, investments, etc. Others are, of course, possible.

Again, feed back from a producer to a sales rep can help the sales rep understand the needs of the producer and assist in helping the producer make the best seed selection decisions. But the feed back and producer decisions can involve not only seed but at least some of these ancillary things. One could be Environmental Classification.

5. Pricing Strategies Examples

As discussed somewhat previously, the methodology can be used in conjunction with pricing strategies with the producer. A few examples are as follows. Discounts could be given for producers that utilize Environmental Classification services discussed previously. Value pricing could be offered for seed with certain genetics, traits, or characteristics. Discounts could be given for producers that choose older varieties or hybrids over newer ones.

Another example could be incentives such as discounts or payments if a producer buys a seed product or steers another producer to do so. Incentive discounts or payments could be made if the producer expands the amount of business with the seed company. There could even be customer appreciation awards, discounts, or payments.

6. Alternative Exemplary Embodiment Example

The exemplary embodiment of FIGS. 1-4 is based on obtaining information for a producer. That producer information is then combined with other information and presented to the producer. The producer information in the embodiment of FIGS. 1-4 is yield map data (e.g. from the yield monitor used by the producer when harvesting a field). It is to be understood that the invention applies likewise to other information from or about the producer or the producer's crops or fields or operations. It is not limited to yield data.

For example, instead of (or in addition to) yield data, what will be called “As Planted” map data can be obtained from the producer. Essentially, precision-farming equipment can store geo-referenced or what might be called spatial information about what was planted and where. It could also include date and time of planting. Cooperating producers would allow the sales rep(s) to copy their memory card information containing GPS data and time (e.g. by using GPS time signals) and where, when, and what they planted in each field. This could also be entered into a database using the internet or through other means.

The “As Planted” maps could be sent to Mapping Center 40 or the like. A CD-ROM or other electronic or paper copy could be made for producer archival purposes. The same information could be entered into a master database for use by the seed company.

Additional information could be added and a customized report analogous to report 100 created. The sales rep could bring the CD-ROM and report to the producer and discuss them face-to-face.

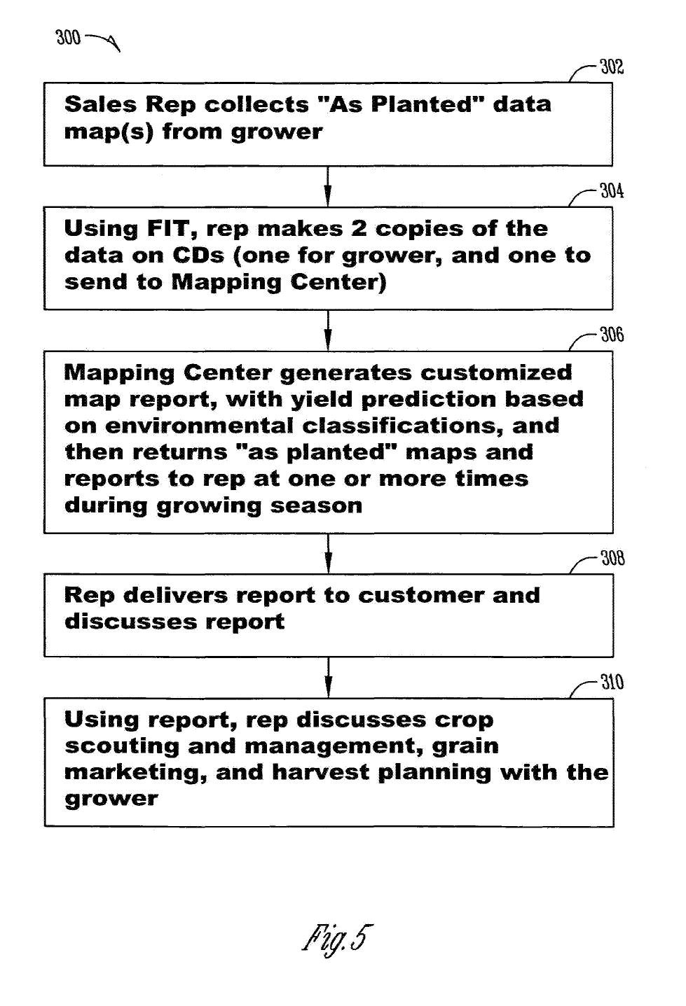

FIG. 5 gives one example of such an alternative embodiment. It is like method 200 of FIG. 2 with the following main differences.

As stated, the data from the producer is the “As Planted” maps of the producer's fields. See step 302 of method 300 of FIG. 5. One copy of the data is copied to an archival CD for the producer; another is sent to Mapping Center 40. See step 304.

Mapping Center 40 combines the “As Planted” maps with a Environmental

Classification that allows predictions of yield. See step 306. It could also include information about variety or hybrid, or specific identification of genetics of the seed or plants.

The sales rep provides the CD and a report back to the producer during the growing season. Step 308. This can provide intelligence and assistance in such things as, inter alia, crop scouting and management, grain marketing, and harvest planning. Step 310. As can be appreciated, the method can be repeated a plurality of times during the growing season, or steps 304-310 repeated after receiving the “As Planted” maps from the producer. Method 300 may best be practiced by delivering the “As Planted” maps to Mapping Center 40 electronically through a wide area communications link, and delivering the archival version and the report back the same way. Alternatively, the producer might at least be able to access his/her “As Planted” maps and report via authorized access to a Mapping Center website.

Growers do not typically have access to this kind of hybrid or variety specific information or access to spatial weather data to make these calculations. Typically producers would make field visits and fine-tune their expectations through experience. New spatial weather data, Environmental Classification, and internet delivery and exchange of information would allow creation of this information and internet allows producers to access of this type of information in nearly real-time.

Thus, method 300 of alternative exemplary embodiment shows another way in which data obtained from the producer can be combined with added value information from the seed company (here including Environmental Classification) to assist in customer relations. Although method 300 of FIG. 5 takes place well ahead of harvest of the crop, it can be valuable to both producer and seed company in similar ways previously described regarding method 200 of FIG. 2. It can help the sales rep and seed company provide services and get future sales from producers. It can help the producer plan and manage his/her operations and communicate with business partners. It can help the seed company with planning and research and development.

Other information that might be of interest, and could be incorporated into maps or other information that is presentable to producers for their fields includes moisture data, “as applied” information (e.g. what chemicals to what land—for example, herbicides, insecticides, fertilizers, etc.).

As can be appreciated, other options and alternatives are possible. As can also be appreciated, the invention can take a variety of different forms and combinations. Some of those forms and combination are set forth in exemplary claims of aspects of the invention set forth below.

What is claimed is:

1. A method comprising:
receiving, at a processor, from a crop producer, geo-referenced crop data that indicates performance of a crop variety at a field location;
correlating, at a processor, genetic information with the geo-referenced crop data; and
determining, at a processor, crop performance data indicative of performance of the crop variety, based on the correlation of genetic information with the geo-referenced crop data.

2. The method of claim 1, further comprising receiving management data correlated with the geo-referenced crop data.

3. The method of claim 1, wherein the geo-referenced crop data further comprises at least one of as-applied data, as-planted data, or harvest data.

4. The method of claim 1, wherein the geo-referenced crop data comprises environmental data or physiological landmark data at the field location.

5. The method of claim 4, wherein the environmental data or physiological landmark data at the field location comprises at least one of wind, drought, soil pH, planting dates, harvesting dates, irrigation, tiled area, previous crop, fertilizer levels, insecticide, herbicide, biotic data, weather, moisture data, precipitation, drought, solar radiation, soil type, or temperature.

6. The method of claim 1, wherein the data that indicates performance of the crop variety at the field location comprises yield data.

7. The method of claim 1, further comprising generating a map associated with the field location using the geo-referenced crop data.

8. The method of claim 7, wherein the map is a yield map.

9. The method of claim 1, wherein the geo-referenced crop data is received from a precision farming system.

10. The method of claim 1, wherein the geo-referenced crop data further comprises crop practices.

11. The method of claim 1, wherein the geo-referenced crop data further comprises phenotypic data.

12. The method of claim 1, wherein the genetic information comprises genotype or genetic trait data.

13. A system comprising:
a processor; and
computing memory having stored therein instructions that when executed by the processor perform the following:
receiving geo-referenced crop data that indicates performance of a crop variety at a field location;
correlating genetic information with the geo-referenced crop data; and
determining performance data indicative of performance of the crop variety, based on the correlation of the genetic information with the geo-referenced crop data.

14. The system of claim 13, wherein the geo-referenced crop data is collected from a crop producer who grows the crop.

15. The system of claim 13, wherein the geo-referenced crop data comprises environmental data or physiological landmark data at the field location.

16. The system of claim 15, wherein the environmental data or physiological landmark data at the field location comprises at least one of wind, drought, soil pH, planting dates, harvesting dates, irrigation, tiled area, previous crop, fertilizer levels, insecticide, herbicide, biotic data, weather, moisture data, precipitation, drought, solar radiation, soil type, or temperature.

17. The system of claim 13, wherein the genetic information comprises genotype or genetic trait data.

18. The method of claim 1, wherein the geo-referenced crop data further comprises phenotypic data.

19. The system of claim 13, further comprising generating a yield map associated with the crop variety at the field location using the geo-referenced crop data.

20. The system of claim 13, wherein the geo-referenced crop data is received from a precision farming system.
